(19) United States
(12) Patent Application Publication
(10) Pub. No.: US 2016/0284233 A1
(43) Pub. Date: Sep. 29, 2016

(54) Apparatus and method of playing a board game for teaching fundamental aspects of personal finance, investing, accounting, wealth management and estate planning

(71) Applicant: Matthew Whitehead, Davie, FL (US)

(72) Inventor: Matthew Whitehead, Davie, FL (US)

(21) Appl. No.: 14/671,301

(22) Filed: Mar. 27, 2015

(51) Int. Cl. G09B 19/22; G09B 19/00

(52) U.S. Cl. CPC G09B 19/22; G09B 19/00

(57) ABSTRACT

A board game for teaching the principles of personal finance whereby significant wealth may be accumulated includes a playing board having a first, Daily Grind, track and an interconnected second, Diamond Cut. Each player selects a game piece and begins the game on the Daily Grind track. Collectively, they start by making formative level decisions and purchases that influence how they start financially, professionally and personally. The items they buy in the Formative stage are added to their game piece. Then they take turns rolling the dice one time and based on the outcome combined with their earlier decisions they get to choose from the set of matching game cards. The Game Card is configured as a combined Income/Balance Sheet, and basic accounting rules of personal finance are carefully followed in updating the Game Card while a player progresses along the Daily Grind, initially in Growth Mode. The Daily Grind track includes spaces on which a player can land which presents unexpected financial obstacles, but the Daily Grind also includes spaces which present financial opportunities. By prudently investing as opportunities arise, a player may obtain passive income in addition to a salary. At a designated time, all players shift playing modes from growth to Transition Mode where they also begin to focus on future generations. Once a player's Self-sufficiency Quotient exceeds their expenses, two different things result 1) the player moves to the Diamond Cut for further play, and 2) all existing players in the Daily Grind reset as their next generation and they restart playing as their family member and continue to play to exit the Daily Grind. On the Diamond Cut, a player enjoys the greatly improved life of one who has accumulated significant wealth and they now focus on advanced items of Wealth Protection and Generation Transfer. The Diamond Cut track includes spaces on which players experience advanced elements along with interaction with players in the Daily Grind. By prudently positioning to handle key situations, a player earns diamond cuts. However, provision is made for unexpected problems in various Diamond Cut spaces along which a player moves. Thus, a player's ongoing financial condition while on the Diamond Cut is also carefully updated using basic accounting principles of personal finance, wealth management, and estate planning (tracking their progress on separate sheets). The game is played in accordance with formal rules which include provisions for declaring a winner.

aspects of accounting and which further extends this teaching to an understanding of the principles upon which significant wealth may be accumulated, protected and passed on from generation to generation.

### BACKGROUND OF THE INVENTION

It is well known that most individuals and families have difficulty in handling personal finances related to accumulating significant wealth; indeed, most individuals and families deem the attainment of wealth an impossible goal to achieve and do not even seriously consider the possibility. It is their belief that all their income must be dedicated to the ongoing requirements of life, and they consider themselves fortunate if they can retire after many years of labor based upon some sort of pension or retirement plan, augmented with Social Security or some other government program. Often, such retirements turn out to be insufficiently funded such that a “retired” person may be forced to continue to work, at least part time, and a mature retired couple may find their standard of living reduced and yearly deteriorating as the effects of inflation and other factors, such as increased medical costs, take effect.

Nonetheless, a few individuals and families do, over a period of time and with the application of certain principles, attain wealth and are thus able to eliminate or greatly reduce the necessity to work at a formal job and are also able to realize their individual dreams of the sort that require such wealth. Correspondingly, they also achieve the sort of long term security that results from the elimination of financial worries.

The differences between those individuals and families who are able, over time, to accumulate substantial wealth (live on the Diamond Cut) and those who do not (and thus are doomed to live the so-called lives of quiet desperation; i.e., life in the Daily Grind) is that the former somehow understand the dynamics of personal finance and investing. This understanding may be more or less self-taught or intuitive, and the degree of success of a given individual or family usually depends upon just how well the dynamics of personal finance are really understood.

For those that do exit the Daily Grind, their next concern is Wealth Protection and Generation Transfer, namely assuring that their future generations won't be subject to what they had to endure. Those individuals who acquire the knowledge to exit the Daily Grind too often don't continue to learn sufficiently to secure this new found status for their generations that follow. The differences between those individuals and families who are able to assure that their future generations remain outside the Daily Grind (live on the Diamond Cut) and those who do not (and thus see their further generations return to or never exit the Daily Grind) is that the former somehow understand the dynamics of wealth preservation and generational transfer. This understanding may be more or less self-taught or intuitive, and the degree of success of a given individual or family usually depends upon just how well the dynamics of personal finance are really understood.

The basic principles of personal finance, investing, accounting and the accumulation of wealth can be taught although they are certainly not taught in most formal institutions of learning and are, to some extent, inconsistent with the hard work ethic practiced by the majority of individuals and families. Of course, hard work is almost always a start to the accumulation of wealth, but it can be demonstrated that it is not necessary for one to work hard all their life if the known principles of personal finance, investing and accounting leading to the accumulation of wealth are carefully practiced.

The advanced principles of Wealth Protection and Generation Transfer (estate planning) can be taught although they are certainly not taught in formal institutions of learning, nor in most business schools, and are, to some extent, inconsistent with the hard work ethic practiced by the majority of individuals and families. These principles are sometimes taught in expensive and time-consuming seminars. Or, they may be taught in more or less well written books. Some individuals, however, do not have the time or ability to spend the sums needed or even the inclination to attend such seminars or the ability to learn the principles from a book.

Thus, it will be readily apparent that it would be highly desirable to provide a means by which the principles of personal finance, investing, accounting, wealth accumulation, and advanced topics of Wealth Protection and Generation Transfer can be taught in a highly compressed time frame and in a manner that is both fun and, learning wise, highly effective. It is to these ends that the present invention is directed.

### OBJECTS OF THE INVENTION

It is therefore a broad object of this invention to provide a board game which teaches fundamental aspects of personal finance.

Similarly, it is a broad object of this invention to provide a board game which teaches fundamental aspects of investing.

It is another object of this invention to provide a board game which also teaches the importance of formative decisions such as education and extra-curricular type activities.

It is another object of this invention to provide a board game which also teaches fundamental aspects of accounting as applied to personal finance.

It is another object of this invention to provide a board game which also teaches fundamental aspects of accounting as applied to wealth management.

It is yet another object of this invention to provide a board game which further teaches the process of accumulating significant wealth.

It is yet another object of this invention to provide a board game which further teaches uses and importance of insurance products for accumulating significant wealth.

It is yet another object of this invention to provide a board game which further teaches the process of protecting wealth.

It is yet another object of this invention to provide a board game which further teaches the process of transferring wealth from generation to generation.

From another point of view, it is an object of this invention to provide a board game which teaches the foregoing fundamental aspects of personal finance, investing, and accounting and the process of building and accumulating significant wealth in greatly compressed time.

From yet another point of view, it is an object of this invention to provide a board game which teaches the power of passive income and how passive income is obtained.

From still another point of view, it is an object of this invention to provide a game board which includes dual, Daily Grind and Diamond Cut, life tracks and which includes rules and accessories for teaching the science of personal finance, investing basic accounting, the accumulation of significant wealth, the protection of that wealth, and its transfer from generation to generation.

It is also an object of this invention to provide a game board in which a Player first makes formative decisions, then moves on a Daily Grind track, and finally, upon qualification, moves to an entirely separate Diamond Cut to thereby provide a sequential experience.

It is a further object of this invention to provide such a board game in which the teachings resulting from play are essentially self-learned and do not require the intervention of an instructor.

### SUMMARY OF THE INVENTION

Briefly, these and other objects of the invention are achieved by the provision of a board game which includes a first, Daily Grind, track and an entirely separate second, Diamond Cut. Each player makes formative decisions at the beginning of game play, which leads to selecting a profession which includes certain beginning financial information including the cost of living for that player and other ongoing financial information. Mastery of Wealth Preservation & Generational Transfer components determines the winner of a given game. Each player earns a Game Card on which to enter their beginning financial information and also updates as play proceeds while the player is confined to the Daily Grind track. The Game Card is configured as a combined Income/Balance Sheet, and basic accounting rules of personal finance are carefully followed in updating the Game Card. A player progresses along the Daily Grind track in accordance with rolls of dice. The Daily Grind includes spaces on which a player can land which, for example, presents unexpected financial situations and obstacles set forth on Mis(haps/steps/cellaneous) and Family playing cards, but the Daily Grind also includes spaces on which a player may take advantage of financial opportunities set forth on Opportunity and Market playing cards. The Daily Grind track thus represents the life of ordinary working individuals.

By prudently investing as opportunities permit and tracking such investments on the Game Card in the context of combining, on a single score sheet, not only day-to-day income and expenses, but also passive income which may be realized and grown from investments, a player's passive income can be grown. Once a player's passive income exceeds their expenses, the player moves to the Diamond Cut for further play.

On the Diamond Cut, a player enjoys the greatly improved life of one who has accumulated significant wealth and begins the task of preserving wealth and passing it on from generation to generation. However, as in real life, even life on the Diamond Cut is not without problems, and provision is made for such in the various Diamond Cut spaces and cards along which a player moves in accordance with rolls of dice. A player's progress in life on the Diamond Cut is followed (again, carefully following the basic accounting rules for personal finance and wealth management) on a Game Card which is adapted to such life and is therefore somewhat different from the Game Card used to follow the same player's earlier progress in the Daily Grind. Formal rules set forth the sequence and conditions of play and the conditions under which a winner of the game emerges. Repetitive playing of the game and consequent improved performance teaches a player the principles of accumulating significant wealth, protecting it, and passing it on.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a generalized view of a game board for playing the subject game;

FIG. 2 is a view of a first part of the game board shown in FIG. 1 enlarged to show certain indicia provided in playing spaces;

FIG. 3 is a view of a second part of the game board shown in FIG. 1 enlarged to show certain indicia provided in playing spaces;

FIG. 4 is a view of a third part of the game board shown in FIG. 1 enlarged to show certain indicia provided in playing spaces;

FIG. 5 is a view of a fourth part of the game board shown in FIG. 1 enlarged to show certain indicia provided in playing spaces;

FIG. 6 is a view of a fifth part of the game board shown in FIG. 1 enlarged to show certain indicia provided in playing spaces;

FIG. 7 is an enlarged view of portions of the game board shown in FIG. 1 showing certain indicia in each of six spaces, Opportunity, Family, Market and Mis(haps/steps/cellaneous), reserved for corresponding card types to be drawn during play;

FIG. 8 is an illustration of an exemplary of two Family cards;

FIG. 9 is an illustration of an exemplary of two Dream Makers cards;

FIG. 10 is an illustration of an exemplary of two Market cards;

FIG. 11 is an illustration of an exemplary of two Opportunity cards;

FIG. 12 is an illustration of an exemplary of two Mis(haps/steps/cellaneous) cards;

FIG. 13 is an illustration of an exemplary of two Situational Opportunity cards;

FIG. 14 is an illustration of an exemplary Formative Year's first card;

FIG. 15 is an illustration of an exemplary Formative Year's second card;

FIG. 16 is an illustration of an exemplary Profession card;

FIG. 17 is an example of a Game Card used by each player in tracking that player's performance in playing the game while in the Daily Grind;

FIG. 18 is an example of the main Game Cards used by each player in tracking that player's performance in playing the game while on the Diamond Cut.

FIGS. 19-21 are examples of the additional Game Cards used by each player in tracking that player's performance in playing the game while on the Diamond Cut.

### DESCRIPTION OF THE PREFERRED EMBODIMENT(S)

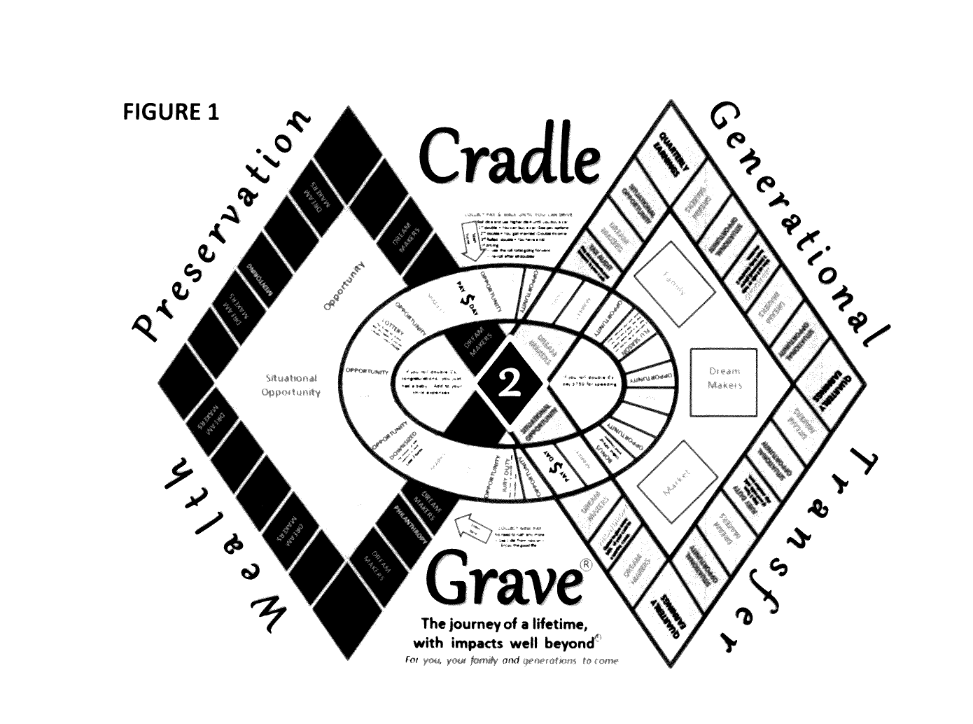

Attention is first directed to FIG. 1 which is a generalized representation of a game board for playing the subject game. A fundamental characteristic of the game board is that there are two tracks for the players to move along: an oval shaped, the Daily Grind, track located in the center and two interconnected diamonds, the Diamond Cut track that surround and cross the in oval track. As will be discussed further below, play starts for all players on the Daily Grind which is representative of the life of many working individuals and families. With skill in handling life and finances on the Daily Grind track, a player may qualify to move to the Diamond Cut in which life is much more secure and enjoyable, although not without potential difficulties which must be managed. On both the Daily Grind track and the Diamond Cut, the game forces a player to practice both financial and investing skills and the accounting skills which highlight what is actually happening to a player's finances to bring about success or failure in the game.

Thus, the Daily Grind and the Diamond Cut, including uncertainties and unexpected events, emulates life such that the skills necessary to practice the lessons learned in playing and becoming more expert at the game may be transferred to real life experiences.

In addition to the Daily Grind track and the Diamond Cut, the game board 1 includes spaces for six types of cards four of which may be drawn from time to time by players as they land on various track spaces in the Daily Grind and two in the Diamond Cut. Space 3 is for Market cards, space 4 is for Family cards, space 5 is for Opportunity cards, space 6 is Mis(haps/steps/cellaneous) cards, space 7 is for Situational Opportunity cards and space 8 is for Dream Makers cards, all as will be explained more fully below.

Each of the spaces shown in FIG. 1 on the Daily Grind track and the Diamond Cut has indicia which is too small to show in FIG. 1. However, the game board is broken up into sections for purposes of illustration as indicated by the subsequent figures.

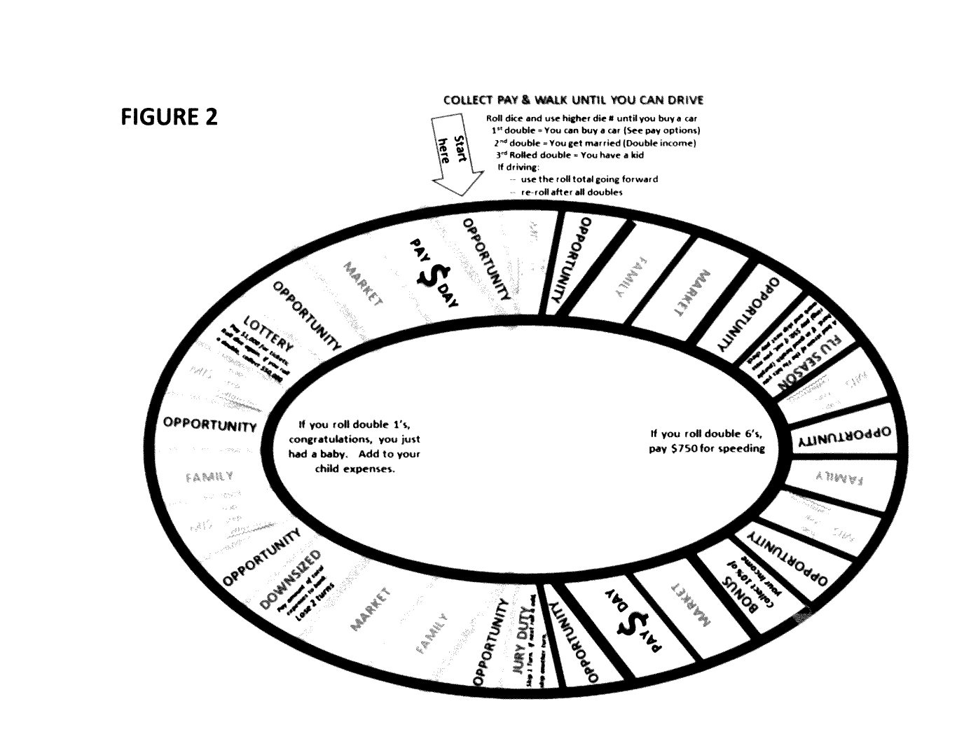

Referring to FIG. 2, it will be seen that the circular Daily Grind track includes segments marked Opportunity, Mis(haps/steps/cellaneous), Family, Bonus, Pay Day, Jury Duty, Market, Downsized, Lottery and Flu Season. The majority of the spaces are associated to cards. Pay Day occurs on the 15M and 30^{th} spaces. It will also be noted that one of the Opportunity spaces has an arrow marked “Start Here”.

As will be explained more completely below in the discussion of the game rules, this space is the starting point for play by all the players and provides additional instruction related to initial rolls and rolling doubles. Other instructions on handling double 1s and double 6s are shown.

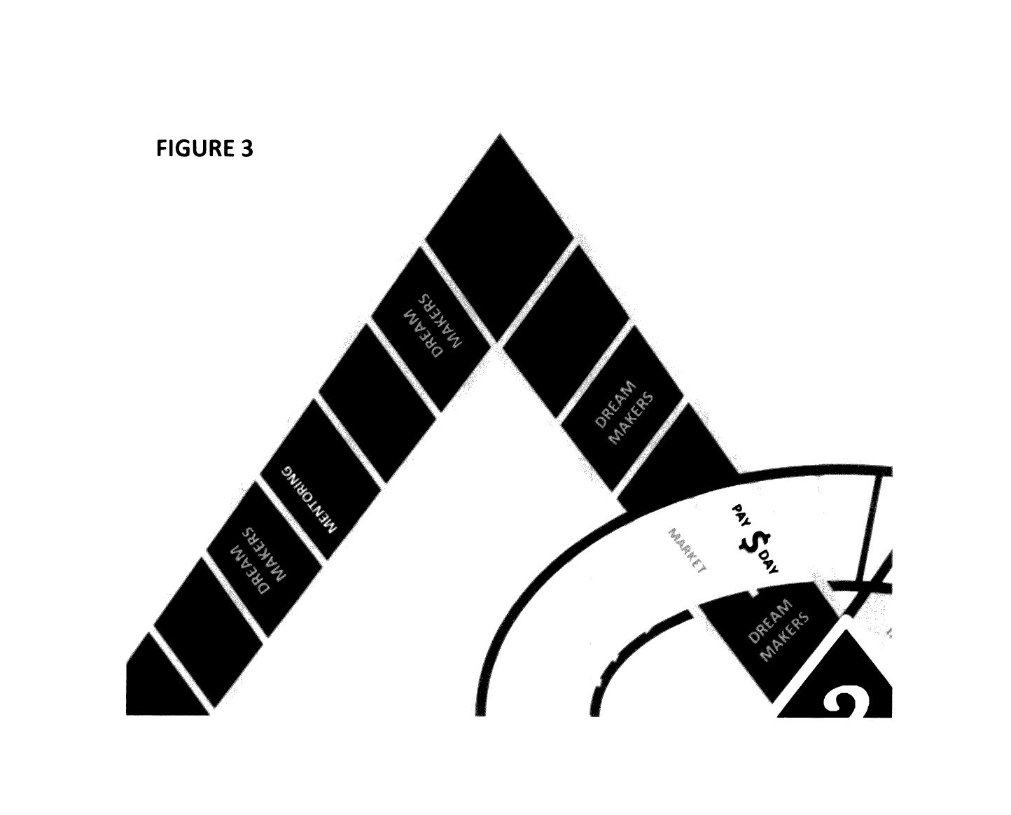

FIG. 3 is an enlarged view of section B (FIG. 1) of the Diamond Cut 3. The two interlocking diamonds Diamond Cut track includes segments marked Dream Makers, Situational Opportunity, Tax Audit, Philanthropy, Jury Duty, Mentoring, Quarterly Earnings, Law Suit and Divorce, along with 8 shared spaces with the Daily Grind ring comprising Market, Family, and Pay Day. The majority of the spaces are associated to cards. Quarterly Earnings occur on each of the outer corners. It will also be noted that one of the Dream Makers spaces has an arrow marked “Enter Here”. As will be explained more completely below in the discussion of the game rules, this space is the continuation point for play by all the players who have successfully exited the Daily Grind, and provides additional instruction related to initial cash and rolling in the Diamond Cut.

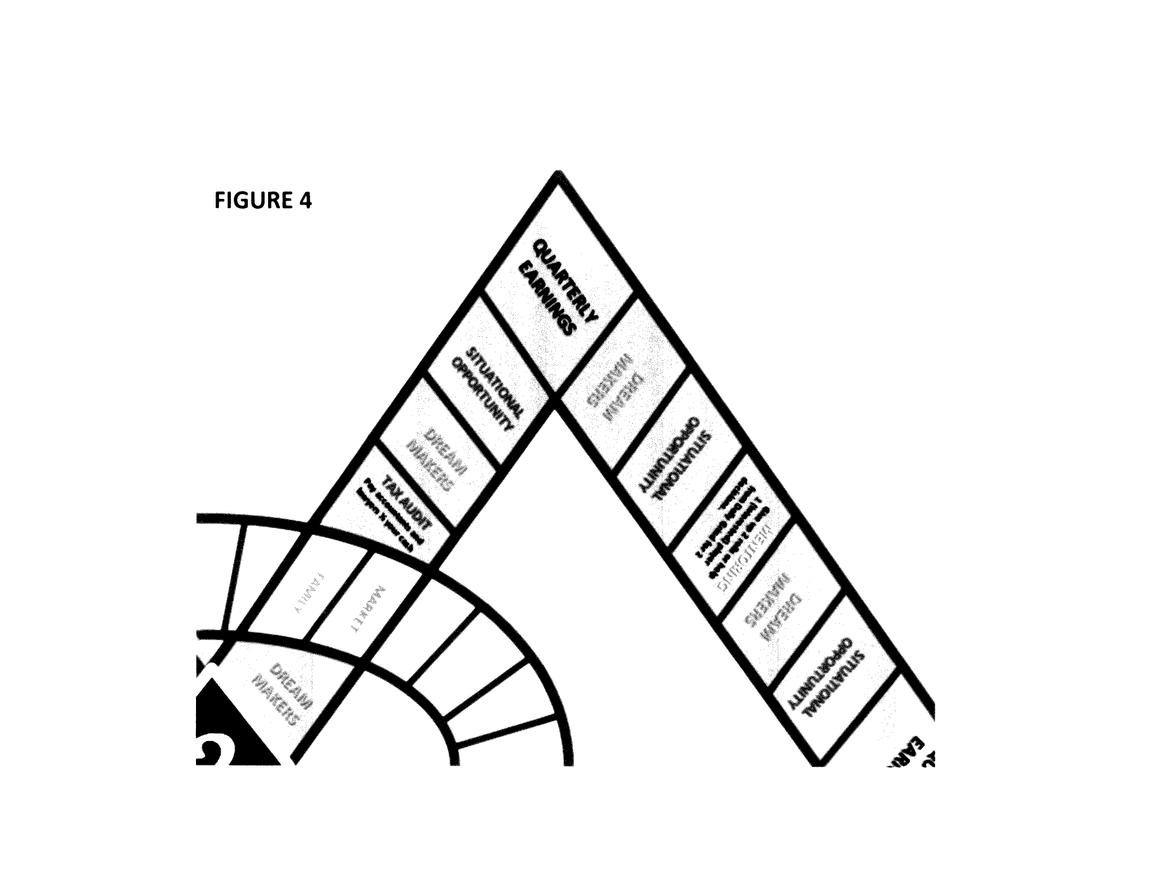

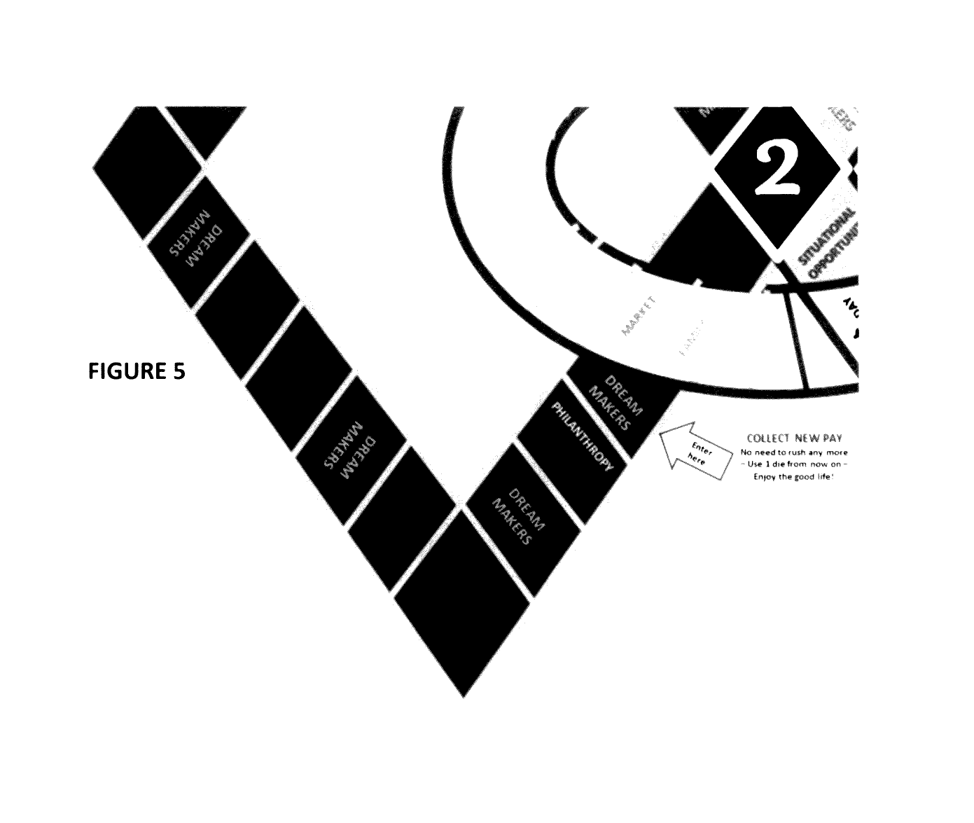

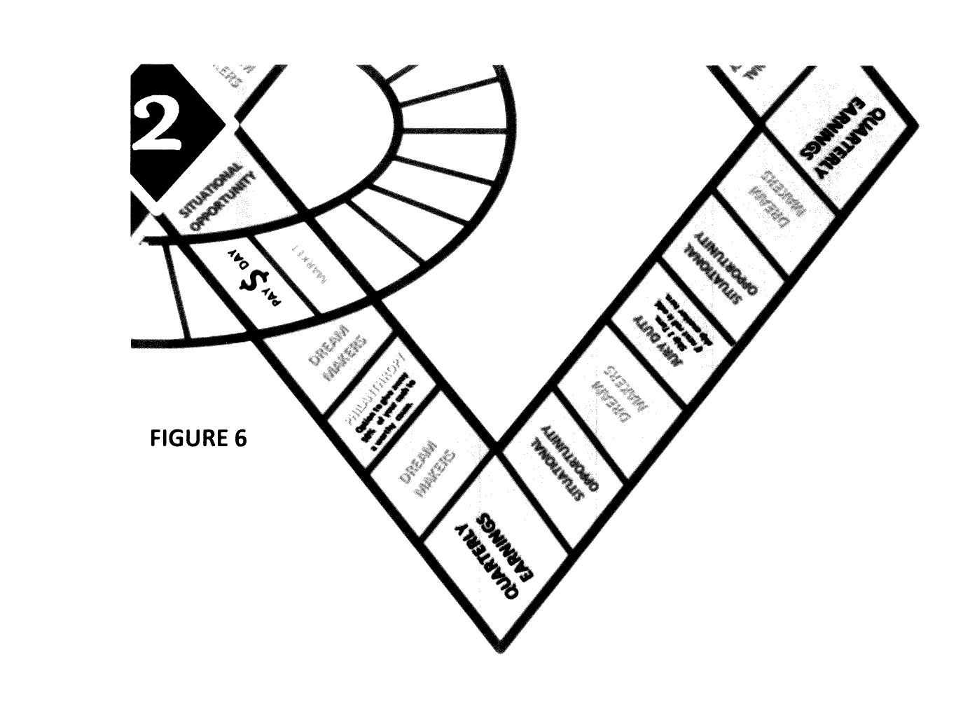

FIGS. 3, 4, 5, and 6 taken together, show the complete Diamond Cut 3 and the abbreviated versions of the more complete legends which appear in the various spaces on an actual game board.

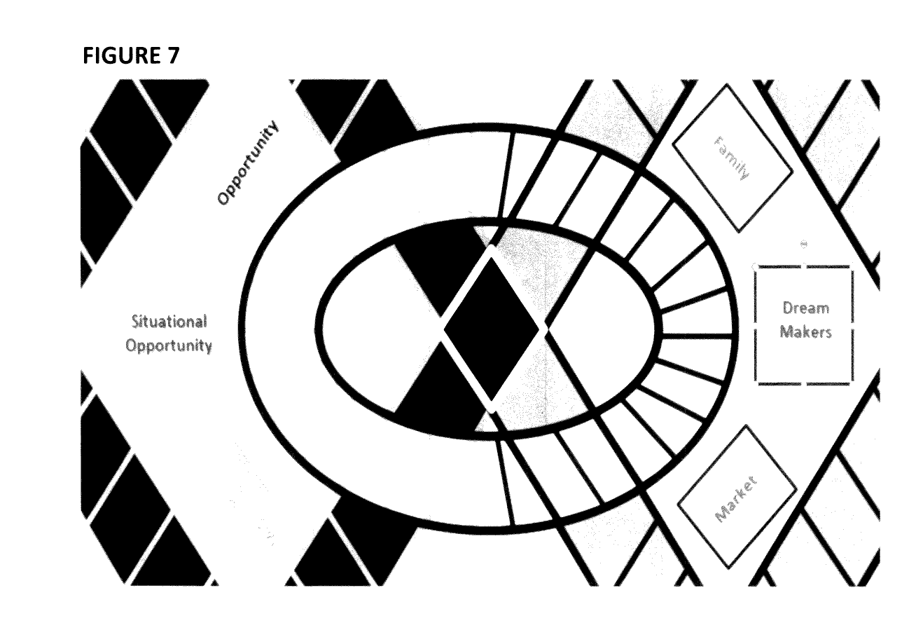

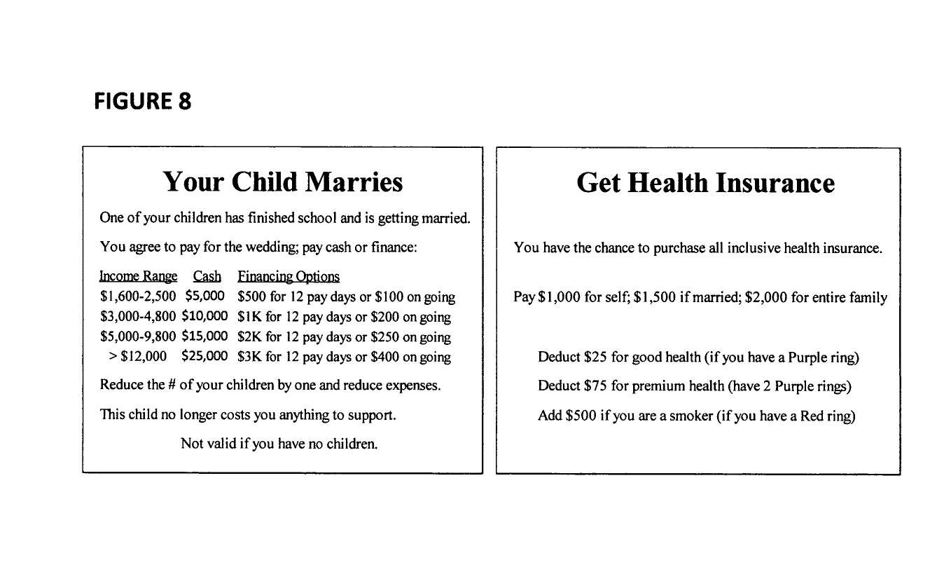

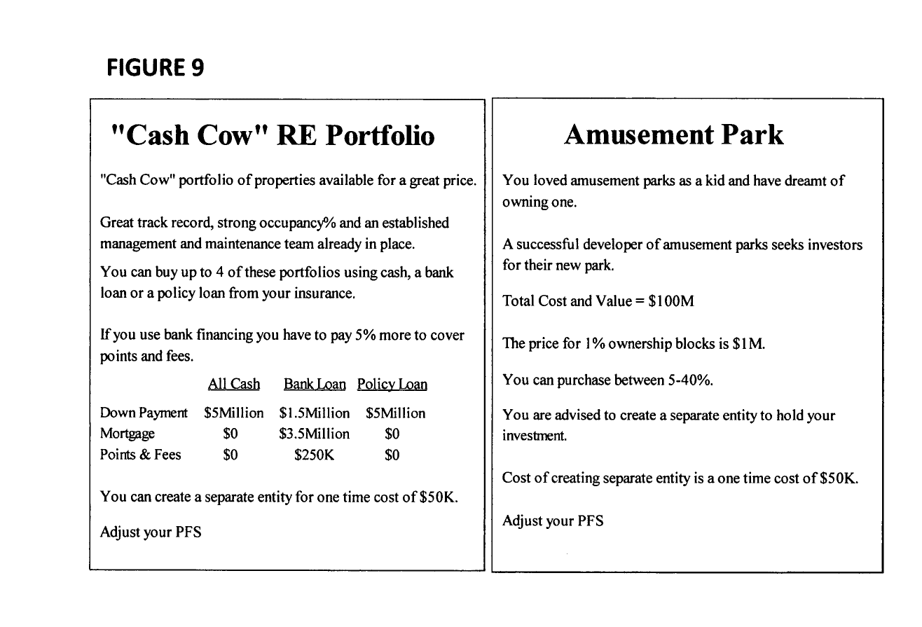

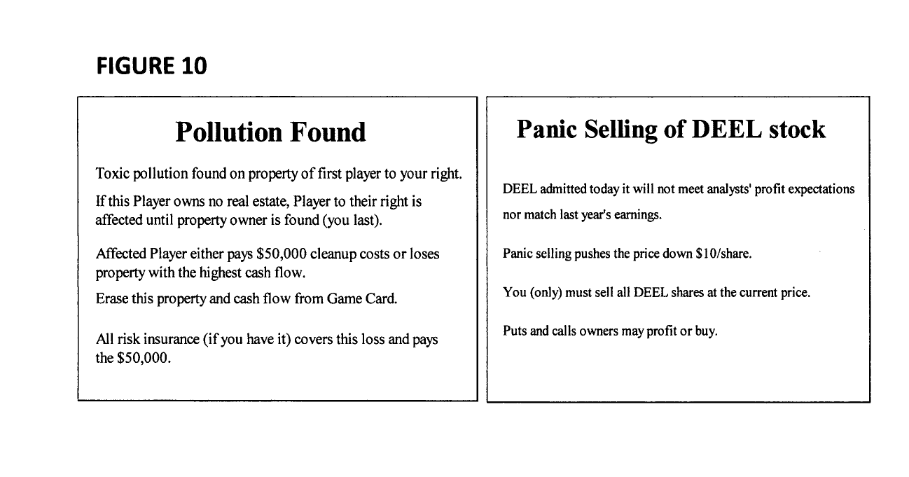

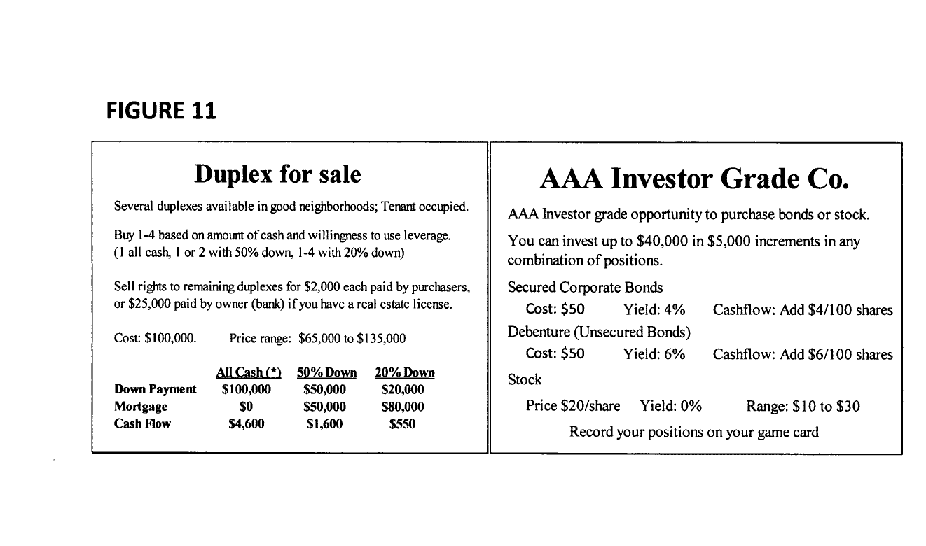

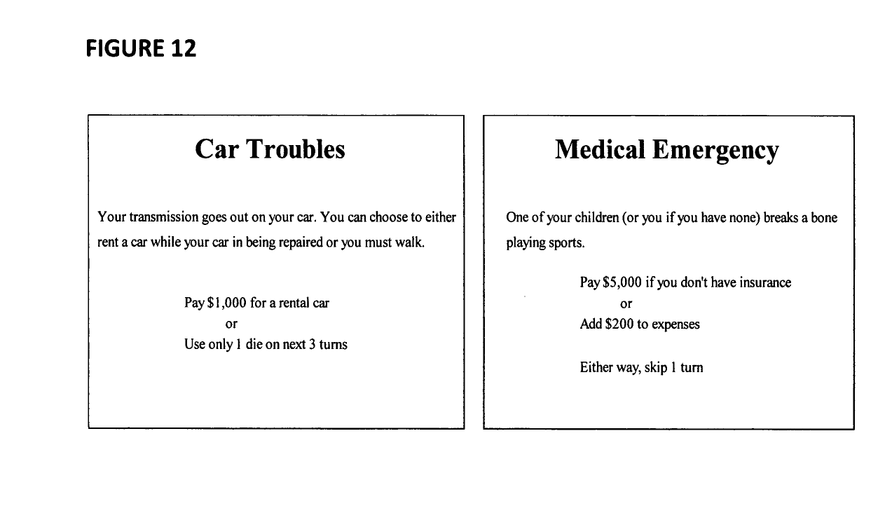

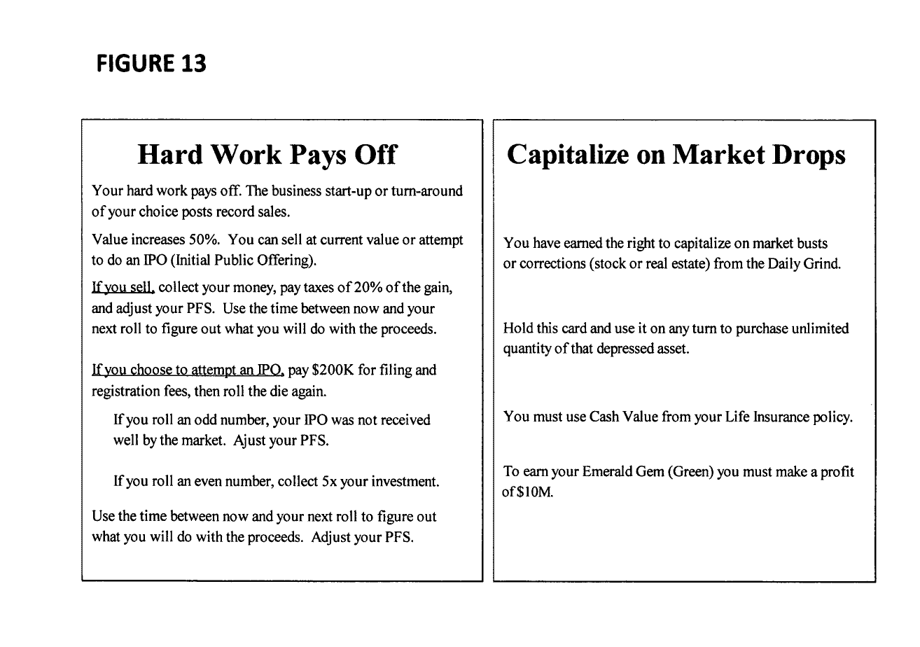

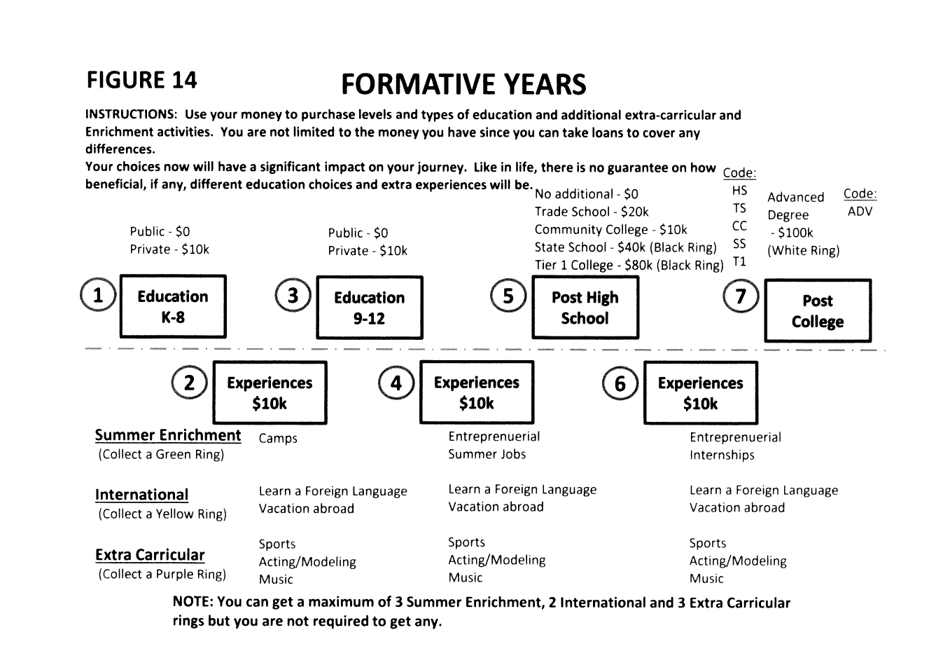

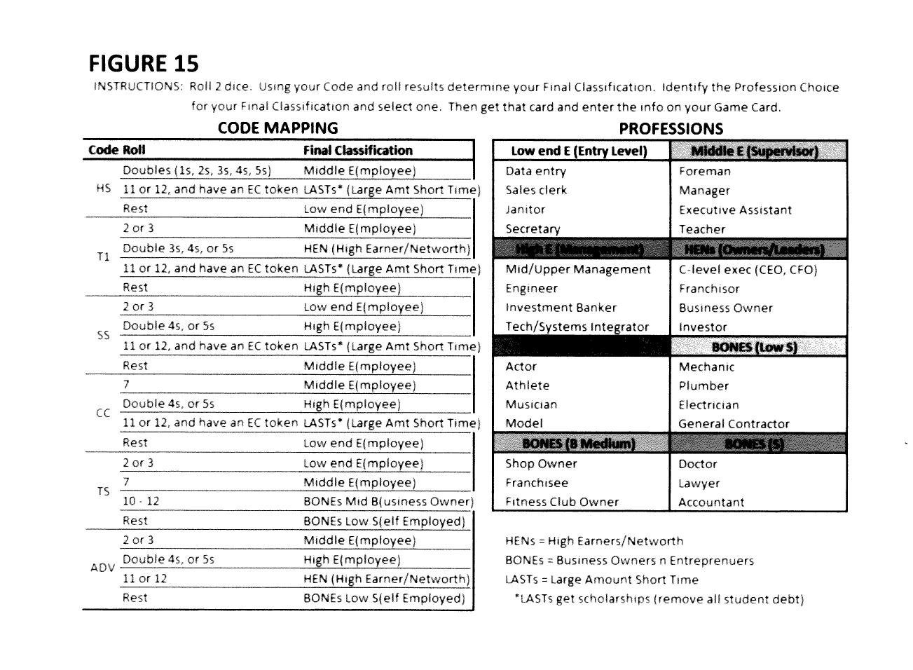

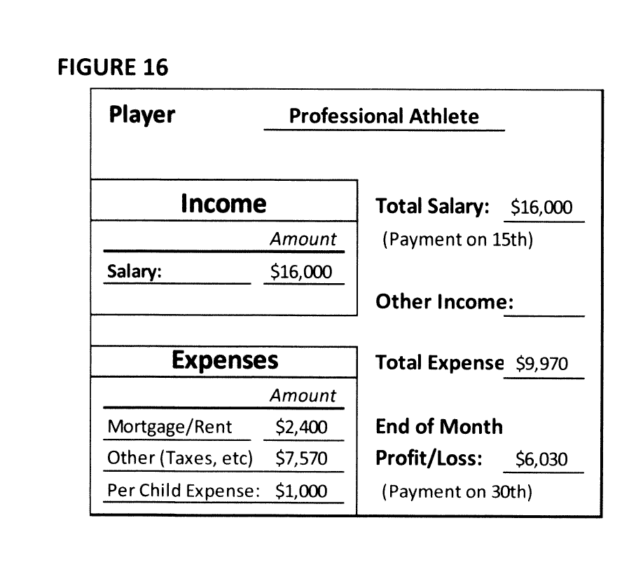

FIG. 7 illustrates the indicia on Family, Dream Makers, Market, Opportunity, Situational Opportunity and Mis(haps/steps/cellaneous) spaces for placing the corresponding cards. FIG. 8 shows an exemplary Family card. Similarly, FIG. 9 shows an exemplary Dream Makers card, FIG. 10 shows an exemplary Market card, FIG. 11 shows an exemplary Opportunity card, FIG. 12 shows an exemplary Mis(haps/steps/cellaneous) card, and FIG. 13 shows an exemplary Situational Opportunity card. FIGS. 14, 15 and 16 illustrates the two cards used in the Formative Years that together dictate how a player arrives at the exemplary Profession card and the information included with each.

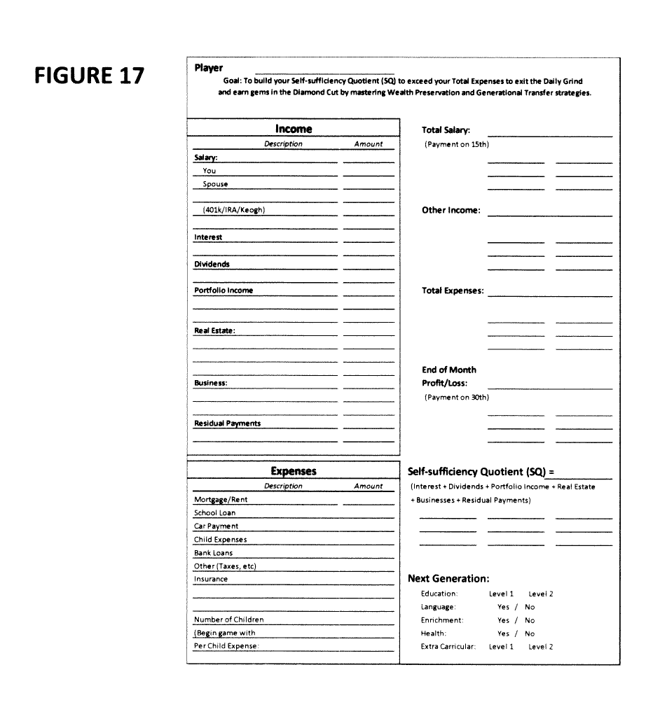

FIG. 17 illustrates the combined Income Statement and Balance Sheet used by each Player Game card while in the Daily Grind.

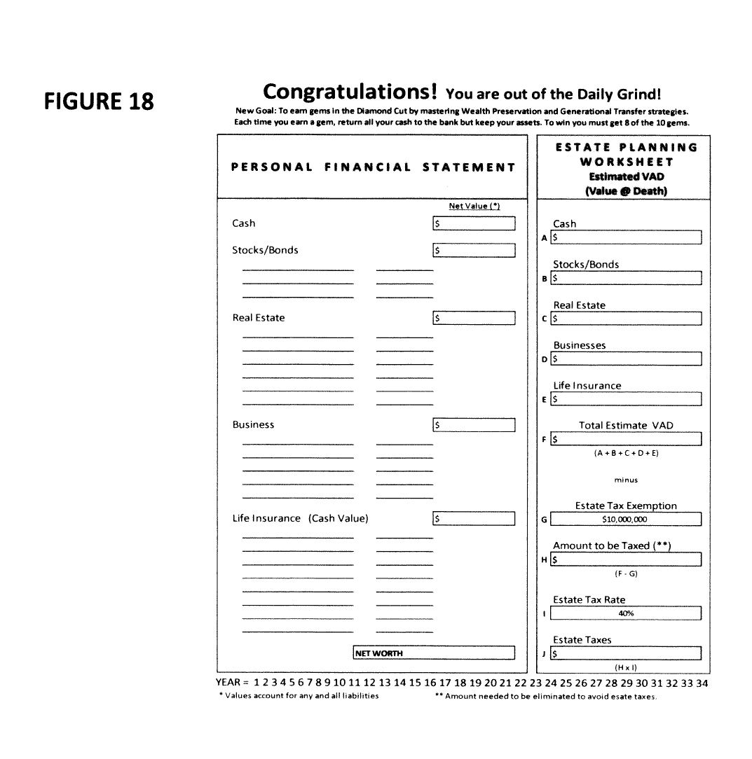

FIGS. 18-21 illustrate the various worksheets used by Players in the Diamond Cut. FIG. 18 is the combined Personal Financial Statement (PFS) and Estate Planning Worksheet used by each Player Game card while in the Diamond Cut.

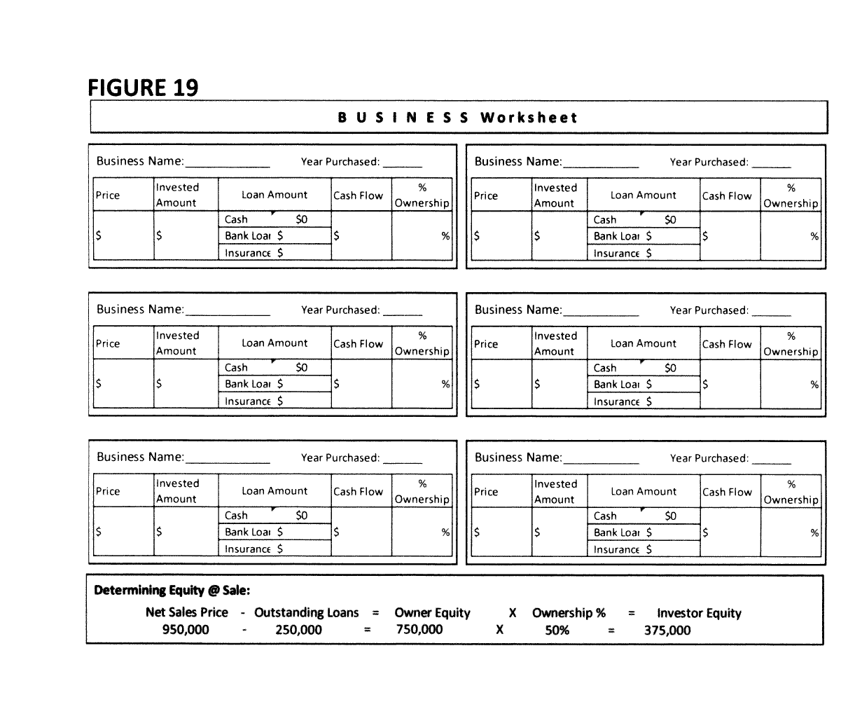

FIG. 19 illustrates one of the additional worksheets used while on the Diamond Cut. It is for tracking businesses.

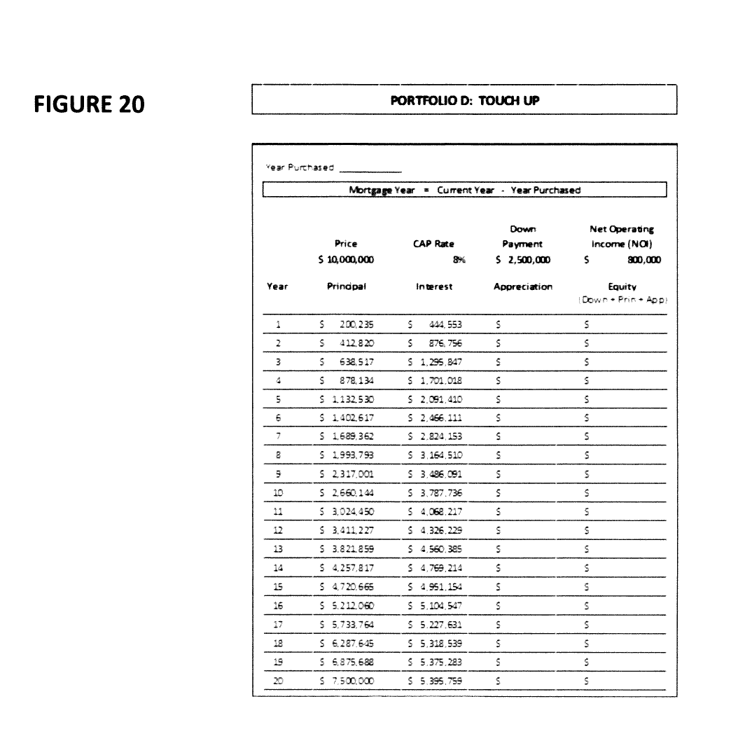

FIG. 20 illustrates one of the additional worksheets used while on the Diamond Cut. It is for tracking real estate and includes a full amortization schedule to show earned equity over time.

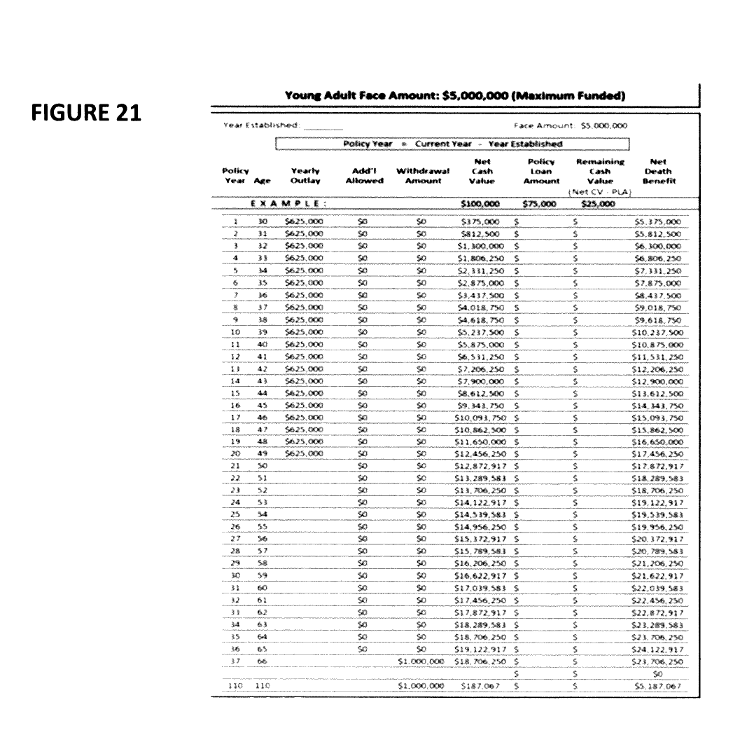

FIG. 21 illustrates one of the additional worksheets used while on the Diamond Cut. It is a life insurance illustration showing various key elements associated with Life Insurance and depicting how Cash Value is earned and grows over time.

### GLOSSARY OF TERMS USED IN PLAYING THE SUBJECT GAME

Asset—Something that puts money “in a Player's pocket”, with minimum labor.

Balance Sheet—A snapshot of a Player's assets and liabilities.

BONEs—Business Owners n Entrepreneurs, this acronym focus on individuals who own and or operate a business, along with entrepreneurs across a wide spectrum of areas make an extremely large amount of salary and or have a large networth.

Capital—Generally called cash or something having an agreed-upon value.

Capital Gain/Loss—The difference between what a Player paid for an investment and what they sold it for.

Cash Flow (CF)—Cash coming in (as income) and cash going out (as expenses). It is the direction of Cash Flow that determines whether something is Income, Expense, Asset or Liability. Cash Flow tells the story.

Cash Offer Vs. Financed Offer—Someone paying all cash versus someone paying a down payment and financing the remainder.

Certificate of Deposit (CD)—A loan to government or a business, issued through a bank, with specified maturity dates and interest rates.

Daily Grind—Where items of value are bought and sold.

Diamond Cut—The outer area of play for players who exit the Daily Grind to earn Gems to win the game.

Dream Makers—Where items of value are bought and sold in the Diamond Cut.

Gems—the coveted prize for players in the Diamond Cut.

Dividend—A payment of profits of a company to the shareholders.

Down Payment—A percentage of the purchase price a Player pays for an investment. The remainder of the price is then financed through other means.

Estimated Net Worth—the right side of the Diamond Cut worksheet, rings, Estimated Net Worth, WP, GenXfer, HENs, BONEs, LASTs, etc???

Foreclosure—A bank or individual takes a Player's property for non-payment of Mortgage.

Formative Years—The initial phase of play where Players select educational and additional experiences they get leading up to getting their playing card and entering the Daily Grind.

Generational Transfer—half the focus of the Diamond Cut, it deals with how to passing wealth down from generation to generation.

HENs—High Earners Networth, this acronym focus on individuals who make an extremely large amount of salary and or have a large networth.

HENs—High Earners Networth, this acronym focus on individuals who make an extremely large amount of salary and or have a large networth.

BONEs

Income Statement—A form showing a Player's Income and Expenses over a period of time. Also called a Profit and Loss Statement.

Inflation—An economic situation where consumer prices rise sharply.

IPO—Initial Public Offering: the first time a company offers shares of stock to the general public.

LASTs—Large Amount Short Time, this acronym refers to entertainers across fields of modelling, music. sports, acting, to name a few.

Liability—Something that takes money “out of a Player's pocket”.

Limited Partnership—A legal entity set up to hold Assets. Allows limited liability with majority of control.

Market—Where items of value are bought and sold in the Daily Grind.

Mis(haps/steps/cellaneous)—Expenses that simply take money out of a Player's pocket. For example, most items purchased in shopping centers are Mis(haps/steps/cellaneous).

Mortgage—If a Player finances the purchase of real estate, the property being financed is used as Collateral against the amount of money being financed.

Mutual Fund—A variety of stocks, bonds and/or securities, grouped together, managed by a professional investment company and purchased by individual investors through shares. The shares possess no ownership value in the various companies in a given Mutual Fund.

Personal Financial Statement (PFS)—the left side portion of the Diamond Cut game card.

Shares Split—When the number of shares in a given investment owned by a Player increases and the price per share decreases. Also known as a stock split.

Situational Opportunity—Where items of value are bought and sold in the Diamond Cut.

Stock Share—A share of stock represents ownership in a corporation. The shareholders (those owning Stock in a corporation) are the actual owners of that corporation.

1031 Tax—Deferred Exchange-A method of buying and selling real estate that allows a Player to defer payment of tax on Capital Gains.

Trading Range—The difference between the highest and lowest price of an investment.

Wealth Preservation—half the focus of the Diamond Cut, it deals with how to maintain wealth, protecting and shielding it

Yield—Amount a Player actually earns from a stock, bond, mutual fund, CD, etc. Similar to ROI.

While the foregoing definitions of financial terms are somewhat simplified, they are adequate for playing the subject game and gaining the financial insight to which it is directed. Consider now the playing of the subject game itself.

Rules of the Subject Game

The game is played in three parts: Formative Years, the Daily Grind and the Diamond Cut.

Part I—Formative Years Each player starts with the same amount of money and purchases levels of education and experiences.

They then roll the dice and based on their roll and mapping to their educational choices, they are assigned a grouping, and ultimately select a profession card and transfer over this information and their financial situation.

Part II—The Daily Grind

Each Player's goal is to get out of the Daily Grind and onto the Diamond Cut. The Daily Grind represents the ongoing life experience of most people and families. To get out of the Daily Grind, a Player must buy investments which gives them cash flow (or passive income) so that the Player's Passive Income is greater than their Total Expenses.

Part III—The Diamond Cut

Once a Player has successfully moved from the Daily Grind to the Diamond Cut, the Player's goal is to earn diamond cuts by demonstrating mastery of several key concepts of Wealth Preservation & Generational Transfer.

The game ends when a player has accumulated 8 of the 10 Wealth Protection and Generational Transfer gems.

How to Set Up the Game

1) The Players “elect” one Player to act as Banker in addition to playing. The Banker should be someone good with numbers and able to handle cash transactions quickly. The Banker must keep their personal money separate from the funds of the Bank. The Banker pays and receives all moneys to and from Players and lends money to Players (see “Bank Loan”).

2) Separately shuffle the “Family” cards, the “Opportunity” cards, “Market” cards, “Mis(haps/steps/cellaneous)” cards, “Situational Opportunities” cards and “Dream Makers” cards. Place them face down on the game board on their respective marked places.

3) Distribute one Income Statement/Balance Sheet to each Player. As shown in FIG. 14, this is a Player's “Game Card” while they are in the Daily Grind. Distribute a marker pen to each Player for use in preparing and updating their Game Card. The Game Cards are single use, typically printed on a pad of numerous blank Game Cards.) The configuration of the Diamond Cut Game Card will be discussed below.

4) Meet your Auditor—this is the person on each Player's right. An Auditor's role is to assist their “client” in making accurate calculations. Each time a change is made to a Player's Game Card, that Player's Auditor must check the resulting calculations. If figures need to be re-worked, then the Player's Auditor should call a short time-out to make corrections.

5) The Banker distributes starting cash (i.e., conventional “play money”) to each Player.

To begin the game:

1) Each Player chooses a playing piece and collects $60,000 from the banker.

2) Each Player places their other playing piece on the Opportunity space designated “Start Here” on the circular Daily Grind track.

3) Each Player rolls two dice, and the Player with the highest total count has the first turn. Play then successively passes to the Player on the left. (The order of play remains the same whether individual Players are in the Daily Grind or on the Diamond Cut).

4) Each Player elects the education and other experiences that they want to pay for and collects the associated rings and adds to their playing piece.

5) Each Player rolls the dice and determines their profession grouping. The Player then selects one of those profession cards.

6) Convert any remaining money from the Formative Years phase into your starting cash. Conversely, capture loan balances from the Formative Years onto your Game Card.

7) Each Player in the Daily Grind rolls two dice on their turn and using the lower value until rolling doubles and purchasing a car, enabling future use of the dice total. The first Player rolls the die and moves around the Daily Grind in a clockwise direction. The other Players follow. (Landing on the same space as another Player has no effect on either Player.)

8) If a Player lands on an “Opportunity”, a “Market”, a “Family”, or a “Mis(haps/steps/cellaneous)” space, they draw a corresponding card. For other spaces landed on, follow the directions stated in the individual spaces.

The Daily Grind

Spaces on the Daily Grind Track

Pay Day—Each time a Player lands on or passes “Pay Day”, the Player receives their Monthly Cash Flow from the Bank. If this amount is negative (minus), the Player must pay it to the Bank. The period from Pay Check to Pay Check is one month. If a Player forgets to ask for their Pay Checks the Player loses it.

Opportunity—When a Player lands on an “Opportunity” space, an “Opportunity” card is drawn. Players may or may not choose to invest in these investment opportunities. Read the “Opportunity” card aloud. Some Deals may allow Players, other than the Player who drew the “Opportunity” card, to buy or sell into the Deal as well. Any investment a Player buys may be sold only if a space, a card or the Rules specifically permit it.

Market—When a Player lands on a “Market” space, a “Market” card is drawn, and the card is read aloud. All Players who have the exact asset mentioned on the card may sell at the specified price. If a Player sells an asset, their Game Card must be adjusted accordingly. After a “Market” card has been played, it is placed on the bottom of the deck.

Family—When a Player lands on a Family space, a Family card is drawn, and the directions on the card are followed. The Player may borrow from the Bank (see Bank Loans) to pay Family card expenses. The drawn Family card is then placed on the bottom of the deck.

Mis(haps/steps/cellaneous)—When a Player lands on a Mis(haps/steps/cellaneous) space, a Mis(haps/steps/cellaneous) card is drawn, and the directions on the card are followed. The Player may borrow from the Bank (see Bank Loans) to pay Mis(haps/steps/cellaneous bills. The drawn Mis(haps/steps/cellaneous) card is then placed on the bottom of the deck.

Flu Season—If a Player lands on “Flu Season”, that Player pays $50 If they possess a health ring (purple). Otherwise they end up missing work and thus the subsequent pay check.

Jury Duty—If a Player lands on “Jury Duty”, that Player skips 1 turn while waiting to see if they are chosen for a jury. After skipping the turn, if the Player's next roll is odd they are selected on the jury and skip another turn.

Lottery—When a Player lands on “Lottery”, a Player must immediately pay $1,000, re-roll the dice, and if they roll a double they received $50,000.

Speeding—When a Player rolls double 6s while driving, that Player pays $750 for speeding.

Baby—When a Player rolls double Is while driving, that Player has a new addition to their family. Upon landing on “Baby”, a Player must immediately do the following:

a) Add the “Per Child Expense” stated on their Game Card to “Child Expenses” on their Income Statement;

b) Take into account the “Per Child Expense” to reach a new Total Expenses figure;

c) Reduce Monthly Cash Flow by the “Per Child Expense”; and

d) Have their Game Card audited.

Downsized—If a Player lands on “Downsized”, that Player has lost their job. The Player must pay the Bank total expenses and also loses two turns.

Other Options Available to Players in the Daily Grind

Paying Off Debt:

A Player may pay off debt to reduce their Total Expenses. The Player must pay off the total amount of the selected debt. Partial payments, except for Bank loans, (see Bank Loans) are not allowed. A Player may do this on any turn.

If a Player pays off a debt, their Game Card is modified as follows:

(a) Adjust the amount of Income Statement Expenses.

(b) Adjust the amount of Total Expenses.

(c) Adjust the amount of Monthly Cash Flow.

(d) Have their Auditor check the revised Game Card.

Bank Loans may be paid off in units of $1,000. Each $1,000 unit of Bank Loan paid off reduces that Player's Monthly Total Expenses by $100. If a Player pays off part of a Bank Loan, in addition to the steps above, the Bank Loan figure on their Balance Sheet is accordingly modified.

Bank Loans: A Player may choose to borrow money from the Bank. Loans are in units of $1,000 at 10% interest per month (per Pay Check). Thus, the monthly interest expense is $100 for every $1,000 borrowed.

When a Player takes a Bank Loan:

(a) Receive the amount borrowed from the Bank.

(b) Add the Bank Loan to the Balance Sheet under “Liabilities”.

(c) Add the Bank Loan payment (10% of the amount borrowed) to the Income Statement Expenses.

(d) Adjust Total Expenses.

(e) Adjust Monthly Cash Flow.

(f) Have the figures audited.

Bankruptcy: If a Players expenses are greater than their income (the Players Monthly Cash Flow is negative), they may choose to declare bankruptcy. If a Player decides to go bankrupt, then the Player must:

(a) Sell their assets for ½ their Down Payment value.

(b) Use the proceeds to pay off debts until the Player's income is greater than their expenses (a positive Monthly Cash Flow).

(c) Lose five consecutive turns.

If, after selling all the Players assets, their Monthly Cash Flow is still negative, then ½ of their loans, not including Home Mortgage and School Loans, are wiped out along with ½ of the corresponding payments.

If the Player still has a negative Monthly Cash Flow, then they are officially out of the game.

The Diamond Cut

A Player moves from the Daily Grind to the Diamond Cut when their Passive Income is greater than their Total Expenses. A Player's goals on the Diamond Cut to earn diamond cut gems by demonstrating mastery of several key concepts of Wealth Preservation & Generational Transfer. The game ends when a player has accumulated 8 of the 10 Wealth Protection and Generational Transfer gems.

When a Player moves out of the Daily Grind onto the Diamond Cut, they get a different set of Game Cards illustrated in FIGS. 18-21 for further score keeping. They, at this time, receives from the Bank 100 times their Passive Income developed during play on the Daily Grind track. This is the amount that the Player receives each time they land on or passes one of the Quarterly Earnings corner squares, lands on Pay Day in the shared space with Daily Grind Day at the beginning of play on the Diamond Cut. Upon landing on the black space intersecting the two diamonds, they collect 2× this amount.

Note: Why does the Player receive 100 times their Passive Income? The scenario is: In getting out of the Daily Grind, the Player has sold all of their investments for great profits and has reinvested that money and had 10 years of outstanding investment success. Thus, the Player has increased their Passive Income 100 times.

To enter The Diamond Cut, the Player changes to an advanced game piece and places it on the space denoted “Enter Here”. Players on The Diamond Cut roll one die moving forward. Two new cards, “Situational Opportunity” and “Dream Makers” cards are now introduced.

Situational Opportunity—When a Player lands on “Situational Opportunity” space, a “Situational Opportunity” card is drawn, and the directions on the card are followed. After taking action, the card is then placed on the bottom of the deck unless otherwise noted on the card.

Dream Makers—When a Player lands on “Dream Makers” space, a “Dream Makers” card is drawn, and the directions on the card are followed. After taking action, the card is then placed on the bottom of the deck unless otherwise noted on the card.

Quarterly Earnings—Each time a Player lands on or passes Quarterly Earnings or lands on one of the shared Pay Day spaces with the Daily Grind, they receive their Quarterly Earnings Income from the Bank. Also, if they land on the intersecting black diamond space they receive 2× their Quarterly Earnings Income. The Player does not have to ask for Income to receive it. If a Player forgets it on the turn they land on or passes Quarterly Earnings, they may still receive it.

Jury Duty—If a Player lands on “Jury Duty”, that Player skips 1 turn while waiting to see if they are chosen for a jury. After skipping the turn, if the Player's next roll is odd they are selected on the jury and skip another turn.

Life on the Diamond Cut is not all roses; thus:

Tax Audit—Player who lands on “Tax Audit” must pay out ½ of their cash to accountants and lawyers.

Divorce—A Player who lands on “Divorce” loses all their cash.

Philanthropy—is optional. If a Player lands oa a “Philanthropy” space, they may give away 50% of their cash to a worthy cause. In doing so, they move closer to earning one of the gems they covet.

Lawsuit—If a Player lands on “Lawsuit”, the cost is $100,000.

Playing the subject game as set forth above teaches the fundamentals of personal finance and investing, the relevant aspects of accounting, the principles behind the accumulation of wealth including the attainment of significant passive income, the protection of that wealth and transferring of that wealth from generation to generation. It has been found that a Player becomes more skillful in playing the game, and hence improves their understanding of the principles of realizing wealth, by playing the game repeatedly, preferably with like-minded individuals as the other Players. Each game takes about four hours to play from beginning to end, and during the course of a single game, years of financial activity are compressed into a single evening of enjoyment.

Accordingly, the basic aspects of personal finance, investing and accounting are effectively taught by playing a board game wherein a player's game card is an integrated income statement/balance sheet and provides a visual and intellectual understanding of the player's financial future, as simulated during game play, by displaying an integrated accounting of the player's cash flow such that:

A) if the integrated income statement/balance sheet shows work income and expenses, but limited income producing assets and limited liabilities, the player is tending, in the simulation, to work for life to meet ongoing expenses and to have few resources late in life, thereby suffering a low standard of living;

B) if the integrated income statement/balance sheet shows work income, liabilities and expenses, but limited income producing assets, the player is tending, in the simulation, to work for life to meet ongoing expenses and to pay off liability obligations in order to have some resources late in life, thereby having a middle class standard of living; and

C) if the integrated income statement/balance sheet shows assets that generate sufficient income to cover expenses, the player is tending, in the simulation, to achieve significant and increasing wealth.

Accordingly, the basic aspects of wealth preservation and generational transfer are effectively taught by playing a board game wherein a player's game card is an integrated Personal Financial Statement (PFS)/Estate Planning Worksheet. Additional work sheets are utilized to track business, insurance and real estate transactions. Combined, these provide a visual and intellectual understanding of the player's advanced financial future, as simulated during game play:

A) if the player obtains none of the gems, they have likely not fully grasped the key concepts around wealth preservation and generational transfer. As such, they stand a good chance of either losing their high standard of living or of having their future generations fall back into the Daily Grind;

B) if the player obtains just a few of the gems, they are beginning to grasp the key concepts around wealth preservation and generational transfer. As such, they stand a decent chance of maintaining their high standard of living so their future generations do not fall back into the Daily Grind; and

C) if the player obtains many of the gems, they have a significant grasp of the concepts of Wealth Preservation and Generational Transfer. Therefore, they are more likely to preserve their wealth and have it transfer from generation to generation.

While the game has been presented in this specification as played on a physical board using physical dice, game pieces, cards, etc., it will be understood that it is readily adaptable to a computer environment provided on a floppy disk, CD ROM or other suitable medium. Further, in such an embodiment, the game can be played by Players at diverse locations via a local area network, wide area network or an extended network such as the Internet. Accordingly, the various terms employed in the above description to identify physical components, such as “board”, “game pieces”. “dice”, “cards”, “tracks”. etc. should be taken to include electronic media equivalents.

Thus, while the principles of the invention have now been made clear in an illustrative embodiment, there will be immediately obvious to those skilled in the art many modifications of structure, arrangements, proportions, the elements, materials, and components, used in the practice of the invention which are particularly adapted for specific environments and operating requirements without departing from those principles.

What is claimed is:

1. A game for teaching formative decision impacts and financial skills to players, said game comprising:
A) a set of individual financial statements for distribution, one each of said individual financial statements to each player, at the beginning of a game;
B) indicia carried by the individual financial statement associated with each player, the indicia of a financial statement assigning a specified initial periodic income and specified initial periodic expenses ascribed to the associated player, the financial statement reflecting periodic income, passive income, expenses, assets and liabilities of the player and being selectively revisable by the associated player to reflect the effects of game events, said periodic income corresponding to an income from a profession, said passive income corresponding to income from interest, dividends, real estate and businesses;
C) indicia of a first set of events comprises indicia of opportunities to participate in specified transactions which include receiving interest, dividends, real estate, businesses and insurance, said indicia of a first set of events applicable to players having passive income less than a predetermined percentage of the player's expenses, each of said first set of events potentially affecting at least one of the periodic income, passive income, expenses, assets and liabilities of the player;
D) indicia of a second set of events applicable to players having achieved passive income greater than a predetermined percentage of the player's expenses, each of said second set of events potentially affecting at least one of the periodic income, passive income, expenses, assets and liabilities of the player; and
E) means for pseudo-randomly designating, in turn, a respective particular game event from the first set of events for each respective player who currently has passive income less than a predetermined percentage of the player's expenses, and a respective particular game event from the second set of events for each respective player who has previously achieved a passive income greater than a predetermined percentage of the player's expenses.

2. The game of claim 1 wherein the individual initial financial statements each comprises an individual card of a set of cards provided for distribution to the players at the beginning of a game.

3. The game of claim 2 wherein each card designates a profession for the player receiving the card.

4. The game of claim 1 wherein the financial statement comprises an income statement and balance sheet.

5. The game of claim 1 wherein the financial statement includes revisable indicia of cash flow.

6. The game of claim 1 wherein the financial statements includes revisable indicia of savings.

7. The game of claim 1 further including revisable indicia of cash on hand.

8. The game of claim 1 wherein the financial statement includes indicia of a profession ascribed to a player.

9. The game of claim 1 wherein the indicia of the first set of events comprises indicia of a plurality of selectable subsets of events, each subset associated with a respective category of event.

10. The game of claim 9 wherein one category of events corresponds to the opportunity to participate in transactions requiring an investment in an amount less than a predetermined amount, and a second category of events corresponds to the opportunity to participate in transactions requiring investment in an amount greater than the predetermined amount.

11. The game of claim 9 wherein one category of the events corresponds to the opportunity to sell a specified asset at a specified price.

12. The game of claim 9 wherein one category of the events corresponds to the opportunity for all players having a specified asset to sell the specified asset at a specified price.

13. The game of claim 9 wherein one category of the events corresponds to changes in the periodic expenses to be ascribed to a player.

14. The game of claim 1 wherein the indicia of the first set of events comprises at least one set of cards, each card representing an event.

15. The game of claim 14 wherein the indicia of the first set of events comprises a plurality of sets of cards, each set of cards associated with a different category of the events, each card in a set of cards representing an event in the associated category.

16. The game of claim 14 wherein the means for pseudo-randomly designating comprises a pseudo-random number generator.

17. The game of claim 16 wherein the pseudo random number generator comprises at least one die.

18. The game of claim 1 wherein the means for pseudo-randomly designating comprises a first sequence of event designators, at least some of said designators in said first sequence corresponding to the occurrence of one of said first set of events, and a second sequence of event designators, at least some of said designators in said second sequence corresponding to the occurrence of one of said second set of events.

19. The game of claim 18 wherein the sequences of event designators comprises first and second separate tracks on a game board, each of said first and second tracks having sequential spaces, each sequential space carrying indicia of an event.

20. The game of claim 1 wherein the means for pseudo-randomly designating comprises a game board and a pseudo-random number generator.

21. The game of claim 20 wherein the pseudo random number generator comprises at least one die.

22. The game of claim 21 wherein the game board includes first and second separate tracks, each of said first and second tracks having sequential spaces, at least some spaces of said first track of sequential spaces reflecting the occurrence of one of said first set of events, and at least some spaces of said second track of sequential spaces reflecting the occurrence of one of said second set of events.

23. The game of claim 1 wherein the indicia of a second set of the events comprises a track of sequential spaces, at least some of said spaces in said track of sequential spaces reflecting the occurrence of one of said second set of events.

24. A method of playing a game for teaching financial skills to players comprising the steps of:
A) providing a set of individual financial statements;
B) distributing one financial statement to each player at the beginning of a game;
C) providing financial information indicia with the financial statement associated with each player, the financial statement assigning a specified initial periodic income and specified initial periodic expenses ascribed to the associated player, the financial statement reflecting periodic income, passive income, expenses, assets and liabilities of the player and being selectively revisable by the associated player to reflect the results of game events, said periodic income corresponding to an income from a profession, said passive income corresponding to income from interest, dividends, real estate and businesses;
D) providing indicia of a first set of events comprises indicia of opportunities to participate in specified transactions which include receiving interest, dividends, real estate and businesses, said indicia of a first set of events applicable to players having passive income less than a predetermined percentage of the players expenses, each of the first set of events potentially affecting at least one of the periodic income, passive income, expenses, assets and liabilities of the player;
E) providing indicia of a second set of events applicable to players having achieved passive income greater than a predetermined percentage of the players expenses, each of the second set of events potentially affecting at least one of the periodic income, passive income, expenses, assets and liabilities of the player; and
F) playing the game in the following manner:
(a) pseudo-randomly designating, in turn, a respective particular game event from the first set of events for each respective player who currently has passive income less than a predetermined percentage of the players current periodic expenses, and a respective particular game event from the second set of events for each respective player who has previously achieved a passive income greater than a predetermined percentage of the players current periodic expenses;
(b) revising the indicia of the financial statement of each player in accordance with the financial effects of each game event on that player; and
(c) repeating steps (a) and (b) until at least one player attains a predetermined goal.

25. The method of claim 24 wherein the predetermined goal comprises a predetermined financial condition.

26. The method of claim 24 wherein the step of ascribing specified initial periodic income and expenses comprises the step of ascribing to each player a respective profession, each profession having an initial salary and initial periodic expenses associated therewith.

27. The method of claim 24 wherein the indicia of a first set of events comprises at least one set of cards, each card representing an event.

28. The method of claim 24 wherein the indicia of a first set of events comprises a plurality of sets of cards, each set of cards associated with a different category of the events, each card in a set of cards representing an event in the associated category.

29. The method of claim 28 further comprising:
A) selecting a respective game piece corresponding to each player,
B) providing a game board including first and second separate closed tracks each having sequential spaces, at least some of the spaces corresponding to the occurrence of the respective categories of the events, and
C) wherein the step of pseudo-randomly designating, for respective players having passive income less than a predetermined percentage of the individual players' expenses, their respective exposure to an event from the first set of the events comprises the steps of:
(a) pseudo-randomly ascribing a number to an individual player;
(b) advancing the token corresponding to the individual player along the track of spaces in accordance with the number; and
(c) distributing to the individual player a card from the set of cards corresponding to the category, if any, associated with the space on which the game piece lands.

30. The method of claim 24 in which the indicia of the first set of events comprises a set of cards, each card reflecting one event of the first set of events.

31. The method of claim 30 in which the game is played on a game board carrying the first and second closed tracks of sequential spaces, and the step of pseudo-randomly designating comprises the step of rolling at least one die.
